(19) United States
(12) Patent Application Publication
(10) Pub. No.: US 2016/0035007 A1
(43) Pub. Date: Feb. 4, 2016

(54) USING A USER WISHLIST TO AUTOMATE THE ACQUISITION AND RENDERING OF A CONTENT ITEM

(71) Applicant: Kobo Inc., Toronto (CA)

(72) Inventor: Cory Taylor, Toronto (CA)

(21) Appl. No.: 14/447,457

(22) Filed: Jul. 30, 2014

(51) Int. Cl. G06Q 30/06

(52) U.S. Cl. CPC G06Q 30/0635

(57) ABSTRACT

A wishlist of content items is associated with a user. The wishlist can include entries which identify individual content items that are deemed to be of interest to the user. A user's progress in consuming a current content item is monitored. From monitoring the user's progress, an event trigger can be detected. The event trigger can correspond to a condition or event that is indicative of the user ending, or alternatively nearing ending his or her consumption of the current content item. In response to detecting the event trigger, a computing device of the user on which the current content item is being consumed obtains a next content item. The next content item can be identified by one of the entries of the wishlist.

### TECHNICAL FIELD

Examples described herein relate to a computing device or system that uses a user wishlist to automate the acquisition and rendering of a content item.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

Some electronic personal display devices are purpose built devices that are designed to perform especially well at displaying readable content. For example, a purpose built purpose build device may include a display that reduces glare, performs well in high lighting conditions, and/or mimics the look of text on actual paper. While such purpose built devices may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links a device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for using a user wishlist to automate the acquisition and rendering of a content item by user, according to an embodiment.

FIG. 2 illustrates an example of an e-reading device for use with one or more embodiments described herein.

FIG. 3 illustrates an example device system for automatic acquisition of content items from a network service using a wishlist, according to an embodiment.

FIG. 4 illustrates an example method for enabling automatic acquisition of a content item from a user wishlist in response to a trigger event relating to the consumption of another content item.

### DETAILED DESCRIPTION

Examples described herein access a user's wishlist of content items in order to enable a device of the user to automatically obtain and render a wishlist content item in a same application session as that used to render another content item. In this way, examples provide that a device can have seamless continuity between the rendering of content items, particularly when the rendering of a current content item ends and the rendering of a next content item is to begin. In the context of e-books, the pages of a current e-book can seamlessly transition to the pages of a wishlist e-book so that the user's reading session is not interrupted by the acquisition of the wishlist e-book.

According to one aspect, a wishlist of content items is associated with a user. The wishlist can include entries which identify individual content items that are deemed to be of interest to the user. A user's progress in consuming a current content item is monitored. From monitoring the user's progress, an event trigger can be detected. The event trigger can correspond to a condition or event that is indicative of the user ending, or alternatively nearing ending his or her consumption of the current content item. In response to detecting the event trigger, a computing device of the user on which the current content item is being consumed obtains a next content item. The next content item can be identified by one of the entries of the wishlist.

Among other benefits, examples described herein provide for the transition from a current content item to a next content item to be seamless and instant. According to one aspect, a next content item is automatically procured by the user on his or her device based on the contents of the user's wishlist. Furthermore, the acquisition of the next content item, as well as the transition from the current content item to the next content item occurs in a same application session. Thus, the user does not have to interrupt or otherwise navigate away from the application used to render the current content item in order to procure and render the next content item.

In the context of e-books, for example, an e-reading device can operate to automatically purchase and download a wishlist e-book upon the user completing a threshold portion of a current e-book. In one implementation, each of (i) the acquisition of the next e-book, and (ii) the rendering of a cover page or first page of the wishlist e-book following the rendering of the last page of the current e-book, occurs within the same session of an e-reading application. Thus, the user does not have to interrupt an e-reading session in order to acquire and seamlessly transition their reading experience to a wishlist e-book.

“E-books” are a form of an electronic publication that can be viewed on computing devices with suitable functionality. An e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., e-reading apps) to view e-books. Still further, some devices (sometimes labeled as “e-readers”) can be centric towards content viewing, and e-book viewing in particular.

An “e-reading device” can refer to any computing device that can display or otherwise render an e-book. By way of example, an e-reading device can include a mobile computing device on which an e-reading application can be executed to render content that includes e-books (e.g., comic books, magazines etc.). Such mobile computing devices can include, for example, a mufti-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Overview

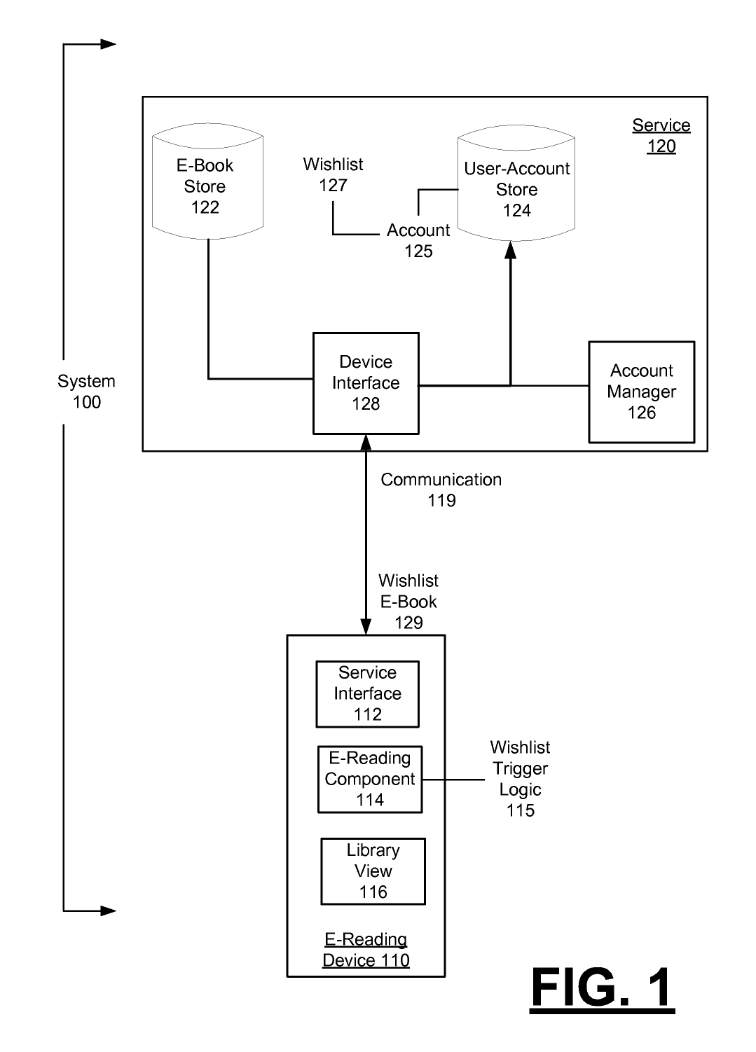

FIG. 1 illustrates a system for using a user wishlist to automate the acquisition of content items by users, according to an embodiment. In an example of FIG. 1, system 100 includes an e-reading device 110 and a network service 120. The network service 120 may include multiple servers and other computing resources that provide various services in connection with one or more applications that are installed on the e-reading device 110. By way of example, in one implementation, the network service 120 can provide e-book services which communicate with corresponding e-book functionality provided on the e-reading device 110. The e-book services can enable e-books to be downloaded or archived from e-reading device 110. The network service 120 can also provide other forms of content for download or streaming, such as videos or music. In this way, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can correspond to a mobile computing device (e.g., tablet) that runs an e-reading application to link the device to the network service 120 in order to enable e-books provided through the service to be viewed and consumed. Still further, by way of example, the e-reading device 110 can be equipped with hardware and software to optimize certain application activities, such as rendering of electronic content (e.g., e-books). For example, the e-reading device 110 can have a tablet like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., content item such as an e-books), which can be stored in the resource store 122. As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other content items that have been purchased for the user account 125, but are not stored on the particular computing device.

In one implementation, the user account 125 can be associated with one or more wishlists 127. The wishlist 127 can include a list of content items that the user is interested in consuming. By way of example, the wishlist 127 can include entries, each of which identify an e-book available for purchase and download. The user can generate entries for the wishlist by providing input through, for example, an interface (e.g., e-reading component 112) of the e-reading device 110. As an alternative or addition, the user can generate entries for the wishlist 127 through a web interface. Still further, the entries for the wishlist 127 can be determined from direct or indirect input of the user with respect to the network service 120 (e.g., user's favorite author, user's favorite genre, etc.). In an implementation in which multiple wishlists exist, each wishlist can be associated with a particular account. Thus, an e-reading device can be associated with multiple accounts, and each account can be associated with a wishlist.

The e-reading device 110 can include a service interface 112, an e-reading component 114 and a library component 116. The e-reading device 110 can execute the service interface 112 to receive resources and data from the network service 120. The service interface 112 can signal the network service 120 an identifier for the user and/or user account. The service interface 112 can interface with the network service 120 to receive resources such as applications and content items (e.g., e-books, music files, etc.) from the network service 120. Optionally, the e-reading device 110 can communicate with multiple services in order to receive resources.

The e-reading device 110 can execute the e-reading component 114 to enable e-reading activities. In particular, the e-reading component 114 can render paginated content from e-books (e.g., electronically formatted literary works, including periodicals).

The library view component 116 can include a user interface that provides a presentation of the content items (e.g., e-books, including magazines and periodicals) in a defined library. The library can include the user's entire collection of e-books, as well as e-books that are being promoted or otherwise displayed through metadata content on the user device. For example, a library can include e-books in a user collection and/or e-books that network service 120 is promoting and/or making available for purchase or download. The presentation of the content items can be based on metadata content associated with the individual content items. For example, in the case of e-books, the metadata content used to display representations of the e-books in the user library can include images provided by the publisher (e.g., icons or graphic objects) which represent or appear as a book cover or jacket. Likewise, in the case of music or movies, representations of the content items in the user's library can be based on icons or graphic objects that represent album art (music) or box cover art (movies).

The e-reading device 110 can include functionality for enabling automatic purchase and download of content items identified in the wishlist 127 from the network service 120. In one implementation, the e-reading component 114 includes a wishlist trigger logic 115 which detects an event for triggering automatic purchase and download of an e-book from the network service 120. The wishlist trigger logic 115 can detect the occurrence of an event in the user's e-reading experience. In one implementation, the wishlist trigger logic 115 can detect the occurrence of an event such as the user ending, or nearing ending, reading a current e-book.

Once the event is detected, the wishlist trigger logic 115 can signal (via the service interface 112) communication 119 to the network service 120. The communication 119 can convey the occurrence of the event, as well as other information such as the identifier of an account and/or the identifier of the e-book being read.

The device interface 128 can associate the communication 119 with the user account 125, from which the associated wishlist 127 can be accessed. The entries of the wishlist 127 can identify the e-books that are of interest to the user. Additionally, the wishlist 127 can be structured so that entries are sequenced. When the communication 119 is received, the e-book of the highest priority entry is identified for the user.

In one implementation, the network service 120 includes an account manager 126 which interfaces with the user-account store 124, and further implements automated steps for implementing a transaction on the user's behalf. The account manager 126 can delete the highest priority entry from the wishlist 127. Additionally, the account manager 126 can debit the user account 125 for the cost of a transaction for the e-book corresponding to the highest priority entry of the wishlist 127. The account manager 126 can also credit the user account with the e-book identified from the wishlist. The device interface 128 then downloads the selected e-book from the wishlist 127 (“wishlist e-book 129”) to the e-reading device 110. As an alternative or variation, the wishlist e-book 129 can be automatically downloaded onto multiple devices associated with the account 125.

While an example of FIG. 1 provides for the wishlist 127 to be provided with a network service, as a variation or addition, the e-reading device 110 can locally store the wishlist 127. More specifically, in one implementation, the wishlist 127 is stored locally, and the wishlist trigger logic 115 executes to (i) detect the trigger event (e.g., user completes 95% of e-book), (ii) access the local version of the wishlist 127 to identify the next e-book the user wishes to read (e.g., corresponding to the highest priority entry), and (iii) sends the communication 119 to the network service 120 in order to purchase and/or download the particular e-book.

In variations, the e-reading device 110 is associated with multiple accounts on the network service 120. For example, the e-reading device 110 can be associated with a primary account (e.g., parent or guardian) and a subsidiary account (e.g., child). Alternatively, the e-reading device 110 can be associated with two accounts, such as spouses who share a device. In such examples, each account can be associated with a wishlist. For example, the user of the particular account can establish a wishlist for themself, or for the account of another user (e.g., parent establishes wishlist for child so that child does not purchase e-book). In such implementations, the wishlist trigger logic 115 can generate the communication 119 to specify the particular account, and the network service 120 can identify and retrieve an e-book from the wishlist of the identified account.

### Hardware Description

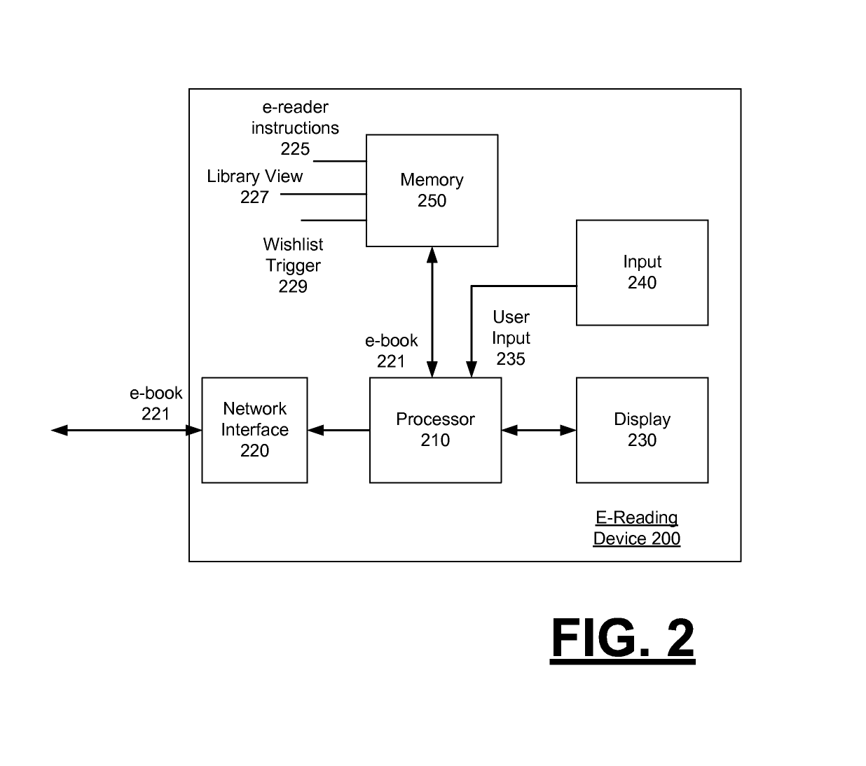

FIG. 2 illustrates an example of an e-reading device for use with one or more embodiments described herein. In an example of FIG. 2, an e-reading device 200 can correspond to, for example, a mobile computing device such as shown by an example of FIG. 1.

With reference to FIG. 2, e-reading device 200 includes a processor 210, a network interface 220, a display 230, one or more input mechanisms 240, and a memory 250. The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., content items such as e-books, configuration files, account information), as well as to provide information (e.g., user account information, service requests etc.). For example, e-reading device 200 can receive application resources, such as media files (e.g., e-books 221) that the user elects to purchase or otherwise download from the network service 120. The application resources that are downloaded onto the e-reading device 200 can be stored in the memory 250.

In some implementations, the display 230 can correspond to, for example, a liquid crystal display (LCD) or light emitting diode (LED) display that illuminates in order to provide content generated from processor 210. In some variations, the display 230 can correspond to an electronic paper type display, which mimics conventional paper in the manner in which they display content. Examples of such display technologies include electrophoretic displays, electrowetting displays, and electrofluidic displays.

In some implementations, the display 230 can be touch-sensitive. For example, the display 230 can be integrated with a sensor layer that is comprised of capacitive touch sensors which trigger with contact to human skin. Alternatively, the display 230 can include alternative sensor layers, such as resistive sensors which can detect applied pressure from, for example, a human finger or stylus.

The processor 210 can receive input from various sources, including from input mechanisms 240 (e.g., buttons or switches, microphone, keyboard), the display 230 (e.g., soft buttons or virtual keyboard) or other input mechanisms (accessory devices). In one implementation, the processor 210 can process multi-touch input detected by the sensor layer provided on the display 230.

In one aspect, memory 250 stores instructions 225 (“e-reading instructions 225”) for operating an e-reading application (e.g., see e-reader component 114 in FIG. 1). The memory 250 can also store library view instructions 227 for providing a library view component (e.g., see library view 116 in FIG. 1). Additionally, the memory 250 can include instructions 229 for providing wishlist logic 115 (see FIG. 1) (“wishlist instructions 229”). The processor 210 can execute the library view instructions 227 to display various forms of lists representing the collection of e-books 221 in the user collection. The processor 210 can execute the wishlist instructions 229 to (i) monitor a user's progress in reading an e-book (or otherwise consuming a media resource); (ii) detect a trigger event signifying that the user is ending, or nearing ending of the e-book (or content item); (iii) signal a communication to the network service 120 to identify the account and the occurrence of the event. The processor 210 can further execute the e-reader instructions 225 to download and render a wishlist e-book 221 received from the network service 120.

### Device System

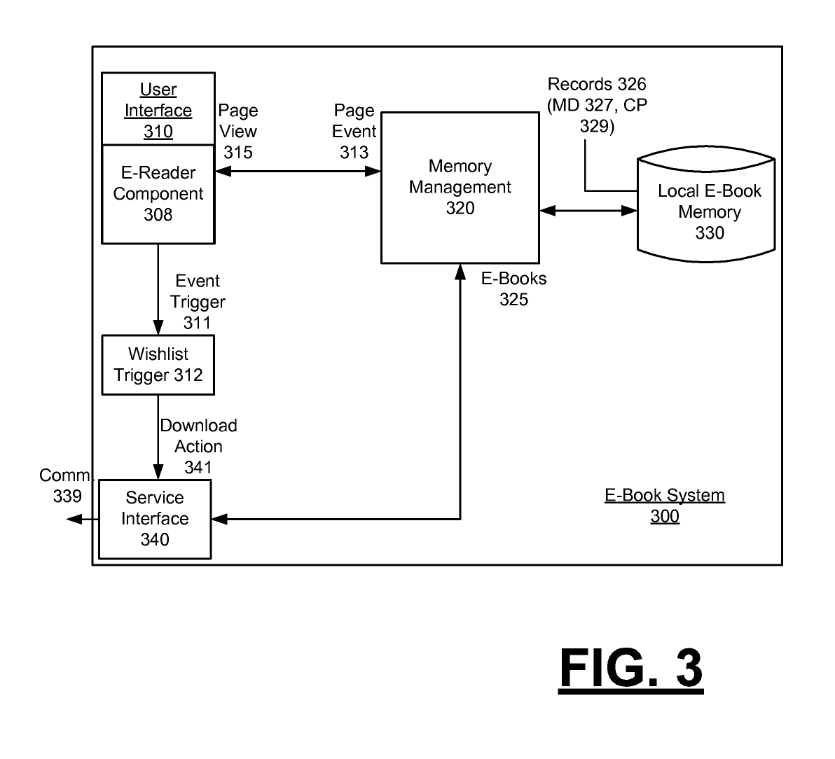

FIG. 3 illustrates an example device system for automatic acquisition of content items from a network service using a wishlist, according to an embodiment. In reference to FIG. 3, a system 300 implements programmatic components for communicating with one or more network service (such as network service 120, shown in FIG. 1), as well as for enabling functionality for viewing and accessing content items (e.g., e-books) utilized by an account associated with the e-reading device 110 (see FIG. 1). In some embodiments, the system 300 can be implemented as an application that runs on an e-reading device, such as shown with examples of FIG. 1 or FIG. 2. In variations, the system 300 can be implemented as part of the operating system for the e-reading device.

In an example of FIG. 3, system 300 includes a user interface 310, a memory management module 320, a local memory 330, and a service interface 340. Some or all of the programmatic components shown with the computing system 300 can be provided in part as operating system-level components. Alternatively, the programmatic components shown with the computing system 300 can be provided as part of an application that runs on, for example, the e-reading device 110 (see FIG. 1). For example, the user can download an application onto the device that is operated as the e-reading device 110, in order to obtain functionality such as described with an example of FIG. 3, as well as to communicate with the network service 120. Alternatively, an application can be embedded or otherwise preinstalled with other programmatic elements for providing functionality such as described with system 300.

The service interface 340 includes application logic which enables the e-reading device 110 to use, for example, a wireless Internet connection, to connect to the network service 120 (see FIG. 1). In connecting with the service, the service interface 340 can transmit data that enables the network service 120 to identify the e-reading device 110 on which system 300 is implemented, so that the network service 120 can determine the account that is associated with the particular e-reading device. In variations in which multiple accounts are associated with the e-reading device, the network service 120 can identify the particular account that is associated with the user's session. The service interface 340 can be used to retrieve e-books 325 from the network service 120. For example, in identifying the e-reading device 110 of system 300 to the network service 120, the network service may be able to procure payment information (e.g., stored credit card information) that can be used to charge the user's account when the user purchases a new e-book from the service. Each e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Individual e-books 325 also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reading device of system 300, the network service 120 can identify what e-books belong to the account associated with the particular device (or device session). The e-books that are transmitted to the e-reading device of system 300 can include, for example, those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reading device 110 to automatically receive their previously purchased e-book. As another example, network service 120 can be configured to push e-books to the e-reading device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-reading device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user.

According to some embodiments, the local memory 330 stores each e-book as a record 326 that includes metadata 327 and content 329 (e.g., page content). The management module 320 can retrieve portions of the content 329 for individual e-books for purpose of rendering e-books via the user interface 310. Additionally, the management module 320 can retrieve metadata 327 to render metadata content (e.g., representations of e-books or lists of e-books) with the user interface 310.

In an example of FIG. 3, the user interface 310 of e-book system 300 includes an e-reading component 308 and a wishlist trigger logic 312. The e-reading component 308 can include functionality to (i) render page views 315 from a particular e-book, and (ii) detect page events 313. The page views 315 can include the content portion 329 of the e-book being read (e.g., opened or rendered). For example, the e-reading component 308 can display a page view 315 from an e-book corresponding to a novel or periodical, and the page view may include text and/or image content. The page event 313 can correspond to, for example, a page turn, a chapter turn, or a clustered page turn.

According to some embodiment, the e-reader component 308 includes, or operates in conjunction with the wishlist trigger logic 312. The wishlist trigger logic 312 monitors the page views 315 and/or other information provided through the e-reading component 308 for a current e-book that the user is reading (i.e., in-progress e-book). In particular, the wishlist trigger logic 312 detects an event trigger 311 from monitoring the e-reading activity performed through the e-reading component 308. The event trigger 311 can signify the occurrence of a condition regarding the progress of the current e-book, such as a condition signifying that the user is nearing an end to reading the particular e-book. By way of example, the wishlist trigger logic 312 can detect the event trigger 311 corresponding to the percentage of the e-book that the user has completed (e.g., 95%) or the estimated time left for the user to complete the e-book (e.g., 3 minutes). Still further, the event trigger 311 can signify the user completing the e-book, or performing some action signifying the end of the e-book (e.g., the user turns to the last page).

As an alternative or addition, the event trigger 311 can signify a manual input from the user, signifying the user's intent to stop reading a current e-book. In one implementation, the user can be provided with a user-interface feature that is provided or displayed with the rendering of the current e-book. The user can provide input through the feature to signify that the user is not interested in reading the e-book further. The user can signal the input for event trigger 311 to trigger the acquisition of another e-book from the user's wishlist.

In response to detecting the event trigger 311, the wishlist trigger logic 312 initiates a download action 341. The download action 341 can correspond to the e-reading device of system 300 generating a communication 339 which identifies the account associated with the system 300 (or the account associated with particular session). The communication 339 can also include information to indicate that the network service 120 is to implement an automatic wishlist download. As described with, for example, an implementation of FIG. 1, the network service 120 can use the communication 139 to identify the account 125 of the user, identify the associated wishlist 127 for the account, identify the highest priority (e.g., next) entry on the wishlist, and then implement an automatic transaction for the corresponding e-book. The transaction can include debiting the account of the user, and further linking the e-book identified from the wishlist with the account of the user.

The service interface 340 can then download the wishlist e-book 325, where it is stored in the local memory 330. In one implementation the memory management module 320 automatically retrieves and displays page views 315 from the wishlist e-book 325 upon the prior e-book being completed (e.g., user completes last page) or terminated (e.g., the user provides input to stop reading the particular e-book).

In this way, the user can acquire another e-book of high interest while maintaining the e-reading activity on the e-reading device. In contrast to conventional approaches, the user does not have to stop reading (e.g., close the e-reading application) in order to perform manual actions for acquiring another e-book. Rather, an example of FIG. 3 provides an example for enabling automatic acquisition of e-books, where the timing for the acquisition can be programmatically determined through, for example, estimation that the user is nearing an end (e.g., as determined by page count or time to completion) to reading the e-book. In this way, the user can transition from reading one e-book (e.g., current e-book) to reading another e-book (e.g., next e-book) without leaving the e-reading environment, or ceasing reading of a book. For example, the user can read a first e-book in a series, and upon turning to a last page, trigger the automatic acquisition of the next e-book in the series (which may be identified from the user's wishlist). Once the user completes the last page of the first e-book, the first page of the second e-book is automatically rendered so that the user can continue the e-reading experience, without quitting use of the e-reading component.

### Methodology

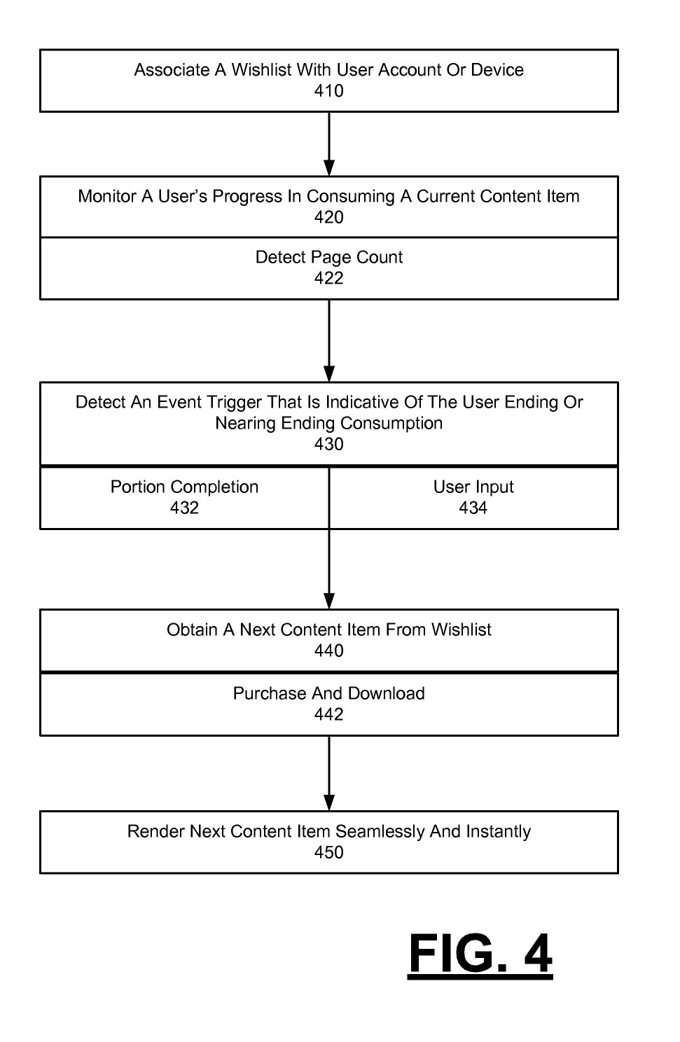

FIG. 4 illustrates an example method for enabling automatic acquisition of a content item from a user wishlist in response to a trigger event relating to the consumption of another content item. An example such as described by FIG. 4 can be implemented using components such as described with FIG. 1, FIG. 2, or FIG. 3. Accordingly, reference may be made to elements of other figures for purpose of illustrating suitable elements or components for performing a step or sub-step being described.

With reference to FIG. 4, a wishlist is associated with a user account or device (410). In one implementation, the user account can be provided in connection with an e-book service, such as provided by network service 120. The account 125 of the user can be linked to the e-reading device 110 of the user.

The consumption of a content item by the user is monitored. In particular, the consumption of the content item can be monitored for the user's progress towards completion (420). For example, the e-reading device of the user can monitor the page count of the user (422). In the context of, for example, a movie or a song, the consumption of the content item can be monitored to detect the user's progress in nearing the end of the movie or song.

According to one aspect, an event trigger is detected that is indicative of the user ending or nearing ending of the consumption (430). In one implementation, the event trigger corresponds to the consumption of the content item passing a milestone, such as the consumption completing a designated portion of the content item (432). By way of example, the event trigger can correspond to the user completing a designated portion of an e-book (e.g., 95%). As another example, the event trigger can correspond to the consumption progressing to a designated threshold, such as the last page or second to last page of an e-book, or to the last minute or 30 seconds of a movie or song.

As an addition or alternative, the event trigger can correspond to a user input which is provided while consumption of the monitored content item is progressing towards completion (434). In one implementation, an e-book can be provided with a feature (e.g., icon) that the user can interact with. The user can select the feature in order to terminate the consumption activity. For example, the feature can be provided with the rendering of the e-book or particular kind of e-book. At some point, if the user elects that a current e-book is not enjoyable, the user can generate an input using the feature to end consumption of the e-current book. While the current e-book is still on display, the e-reading device 110 of the user can signal the communication 119 to the network service 120 in order to download or purchase the e-book corresponding to the highest priority on the wishlist.

In response to the event trigger, the computing device of the user can obtain the next content item on the wishlist (440). In one implementation, the next content item can be purchased and downloaded (442). For example, the e-reading device 110 of the user can identify itself to the network service 120, and the network service can determine the account 125 associated with the device or with the device's session. The wishlist associated with the account 125 can be provided on either the e-reading device or on the network service 120. The communication 119 can trigger an account manager 126 (which can be local on the device or provided with the network service 120) to link the e-book identified by the highest priority entry of the wishlist with the user account. At the same time, the account manager 126 can debit funds from the user account. In this way, the occurrence of the event trigger results in the automatic purchase and download of another e-book as provided for in the wishlist.

Once the next content item is obtained, the computing device of the user renders the next content item seamlessly after rendering the current content item (450). The rendering of the next content item can be seamless, automatic and instant. In particular, the next content item can be displayed immediately after consumption of the current content item ends, without the user exiting or navigating away from the application used to render the existing content item. By way of example, once the user progresses reading of a current e-book to the point where the event trigger is generated, the e-reading device 120 communicates with the network service in order to obtain a next e-book on the user's wishlist. The acquisition (e.g., download with payment) of the next e-book can occur after the event trigger is detected, and the download of the e-book can be transparent and seamless to the user. For example, the user can receive the download while continuing the experience of reading the current e-book to completion. Once the current e-book is complete, the next e-book is displayed to the user.

In one implementation, a cover page or first page of the next e-book can follow the last page of the current e-book, so that the transition from one e-book to the next e-book is instant and seamless. In an implementation in which the user elects to cease consuming the content item (e.g., user does not like an e-book and elects for another), the transition from the current e-book to the next e-book can include displaying the cover page or first page of the next e-book immediately after the last page of the e-book that the user has read. In both examples, the transition from the page of the current e-book to that of the next e-book can occur within the same session of the e-reading application of the user's device.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for providing content items, the method being implemented by one or more processors and comprising:
associating a wishlist of content items with a user, the wishlist identifying one or more content items that are deemed to be of interest to the user;
monitoring a user's progress in consuming a current content item;
detecting, from monitoring the user's progress, an event trigger that is indicative of the user ending or nearing ending in consuming the current content item;
in response to detecting the event trigger, automatically causing a device of the user on which the current content item is being consumed to obtain a next content item that is one of the one or more content items that are identified on the wishlist.

2. The method of claim 1, wherein automatically causing the device of the user to obtain the next content item includes automatically purchasing and downloading the next content item from a network service.

3. The method of claim 1, further comprising automatically rendering the next content item on the device of the user in response to detecting that the user has completed the current content item.

4. The method of claim 1, wherein detecting the event trigger includes detecting that the user has completed consuming a designated portion of the current content item.

5. The method of claim 1, wherein detecting the event trigger includes detecting that the user has completed the current content item.

6. The method of claim 1, wherein:
the wishlist includes multiple entries, wherein each entry of the wishlist corresponds to a specific e-book; and
wherein detecting the event trigger includes detecting that the user completed a designated portion of the e-book.

7. The method of claim 1, further comprising determining a sequence for the entries of the wishlist, wherein the sequence of the wishlist determines which of the content items on the wishlist or obtained as the next content item.

8. The method of claim 1, wherein monitoring the user's progress includes monitoring a page count of the user reading an e-book, and wherein automatically causing the device of the user to obtain the next content item includes automatically purchasing and downloading a next e-book from a network service.

9. The method of claim 1, wherein detecting the event trigger includes detecting the user providing input to terminate consumption of the content item prior to the user's progress in completing the content item being complete.

10. The method of claim 1, wherein the wishlist is stored on a network service, and wherein the method further comprise signaling the network service from the computing device of the user to access the wishlist of the user and to identify the next content item on the wishlist.

11. The method of claim 10, further comprising detecting user input to identify an additional content item for the wishlist, and communicating identification of the content item to the network service in order to add the additional content item to the wishlist.

12. The method of claim 10, further comprising linking an account of the user with the wishlist, and in response to the computing device of the user initiating obtaining the content item by download from the network service, automatically debiting the account of the user.

13. A computing device comprising:
a memory that stores a set of instructions;
one or more processors that use instructions from the memory to:
associate a wishlist of content items with a user of the computing device, the wishlist identifying one or more content items that are deemed to be of interest to the user;
monitor a user's progress in consuming a current content item on the computing device;
detect, from monitoring the user's progress, an event trigger that is indicative of the user ending or nearing ending in consuming the current content item; and
in response to detecting the event trigger, automatically cause a device of the user on which the current content item is being consumed to obtain a next content item that is one of the one or more content items that are identified on the wishlist.

14. The computing device of claim 13, wherein automatically causing the device of the user to obtain the next content item includes automatically purchasing and downloading the next content item from a network service.

15. The computing device of claim 1, further comprising automatically rendering the next content item on the device of the user in response to detecting that the user has completed the current content item.

16. The computing device of claim 1, wherein detecting the event trigger includes detecting that the user has completed consuming a designated portion of the current content item.

17. The computing device of claim 1, wherein detecting the event trigger includes detecting that the user has completed the current content item.

18. The computing device of claim 1, wherein:
the wishlist includes multiple entries, wherein each entry of the wishlist corresponds to a specific e-book; and
wherein detecting the event trigger includes detecting that the user completed a designated portion of the e-book.

19. The computing device of claim 13, wherein the one or more processors determine a sequence the entries of the wishlist, the sequence of the wishlist determining which of the content items on the wishlist are obtained as the next content item.

20. A non-transitory computer-readable medium that stores instructions for organizing e-books on a computing device, the computer-readable medium including instructions that, when executed by one or more processors, cause the one or more processors to perform operations comprising:
associate a wishlist of content items with a user of the computing device, the wishlist identifying one or more content items that are deemed to be of interest to the user;
monitor a user's progress in consuming a current content item on the computing device;
detect, from monitoring the user's progress, an event trigger that is indicative of the user ending or nearing ending in consuming the current content item; and
in response to detecting the event trigger, automatically cause a device of the user on which the current content item is being consumed to obtain a next content item that is one of the one or more content items that are identified on the wishlist.
